(19) United States
(12) Patent Application Publication
(10) Pub. No.: US 2016/0242533 A1
(43) Pub. Date: Aug. 25, 2016

(54) WRITING UTENSIL CARRYING ASSEMBLY

(71) Applicant: Bob Hart, North Highlands, CA (US)

(72) Inventor: Bob Hart, North Highlands, CA (US)

(21) Appl. No.: 14/627,109

(22) Filed: Feb. 20, 2015

(51) Int. Cl. A45F 5/00; B42D 3/12

(52) U.S. Cl. CPC A45F 5/00; B42D 3/12; A45F 2005/008

(57) ABSTRACT

A writing utensil carrying assembly for coupling writing utensils to a book or a user's arm includes a holder to contain a plurality of the writing utensils. A strap is coupled to the holder and the strap may be wrapped around an object to retain holder on the object. A first coupler and a second coupler are each coupled to the strap and the first coupler engages the second coupler.

### BACKGROUND OF THE DISCLOSURE

### Field of the Disclosure

The disclosure relates to carrying devices and more particularly pertains to a new carrying device for coupling writing utensils to a book or a user's arm.

### SUMMARY OF THE DISCLOSURE

An embodiment of the disclosure meets the needs presented above by generally comprising a holder to contain a plurality of writing utensils. A strap is coupled to the holder and the strap may be wrapped around an object to retain holder on the object. A first coupler and a second coupler are each coupled to the strap and the first coupler engages the second coupler.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a writing utensil carrying assembly according to an embodiment of the disclosure.

FIG. 2 is a back side view of an embodiment of the disclosure.

FIG. 3 is a front side view of an embodiment of the disclosure.

FIG. 4 is a left side view of an embodiment of the disclosure.

FIG. 5 is a top perspective in-use view of an embodiment of the disclosure.

FIG. 6 is a perspective in-use view of an alternative embodiment of the disclosure.

### DESCRIPTION OF THE PREFERRED EMBODIMENT

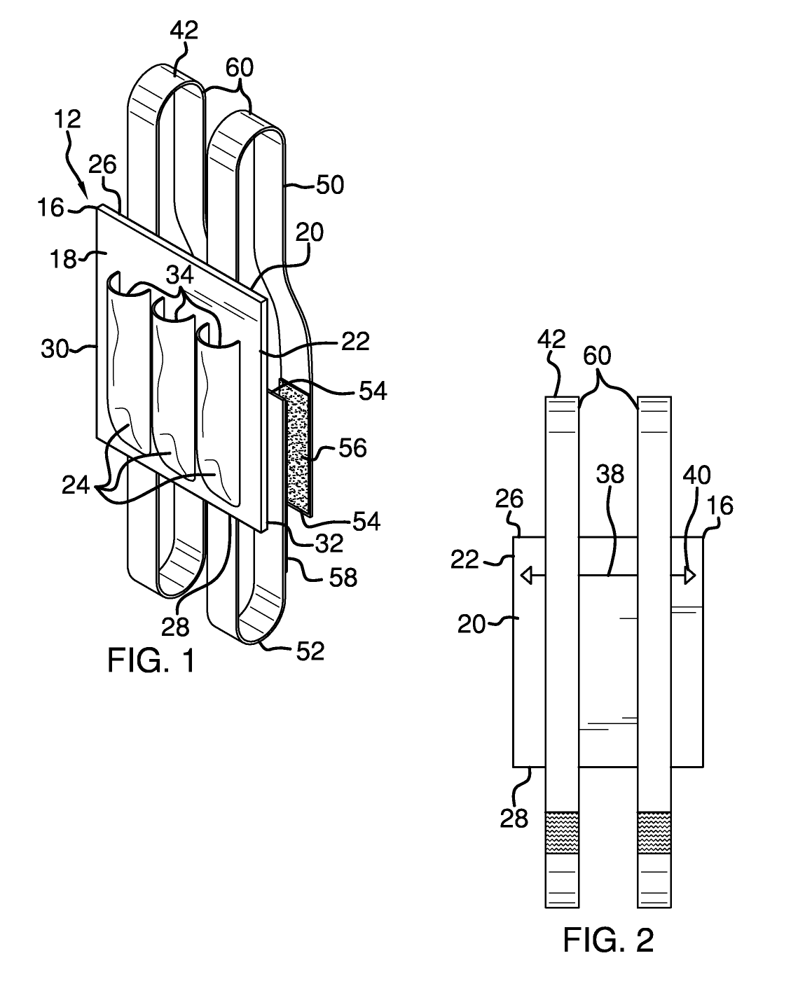

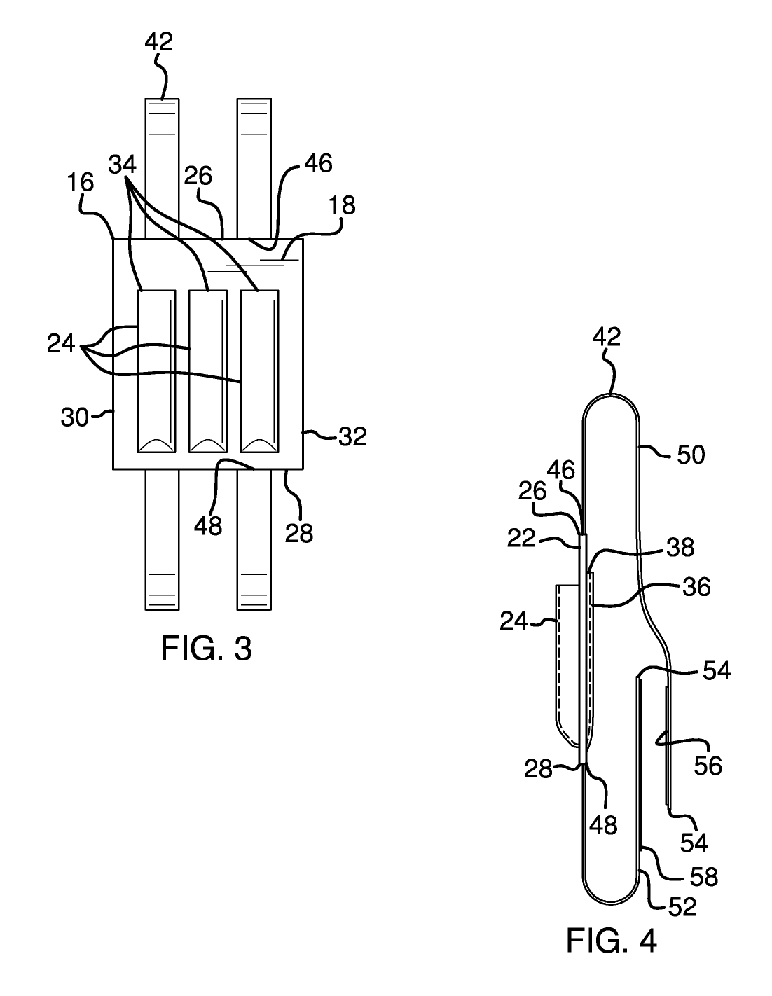

With reference now to the drawings, and in particular to FIGS. 1 through 6 thereof, a new carrying device embodying the principles and concepts of an embodiment of the disclosure and generally designated by the reference numeral 10 will be described.

As best illustrated in FIGS. 1 through 6, the writing utensil carrying assembly 10 generally comprises a holder 12 to contain a plurality of writing utensils 14. The writing utensils 14 may be pens or pencils or the like. The holder 12 comprises a panel 16 that has a front side 18, a back side 20 and a perimeter edge 22 extending therebetween. A plurality of sleeves 24 is coupled to the front side 18 and the sleeves 24 extend between a top side 26 and a bottom side 28 of the perimeter edge 22. The sleeves 24 are spaced between a first lateral side 30 and a second lateral side 32 of the perimeter edge 22. Each of the sleeves 24 has an open end 34 and the open end 34 may insertably receive one of the writing utensils 14.

A pocket 36 is coupled to the back side 20 and the pocket 36 has an aperture 38 therein to insertably receive an item 40. The aperture 38 may have a closure 40 comprising a zipper or the like. A strap 42 is coupled to the holder 12 and the strap 42 may wrapped around an object 44 such that the holder 12 is retained on the object 44. The object 44 may be a cover of a book or the like.

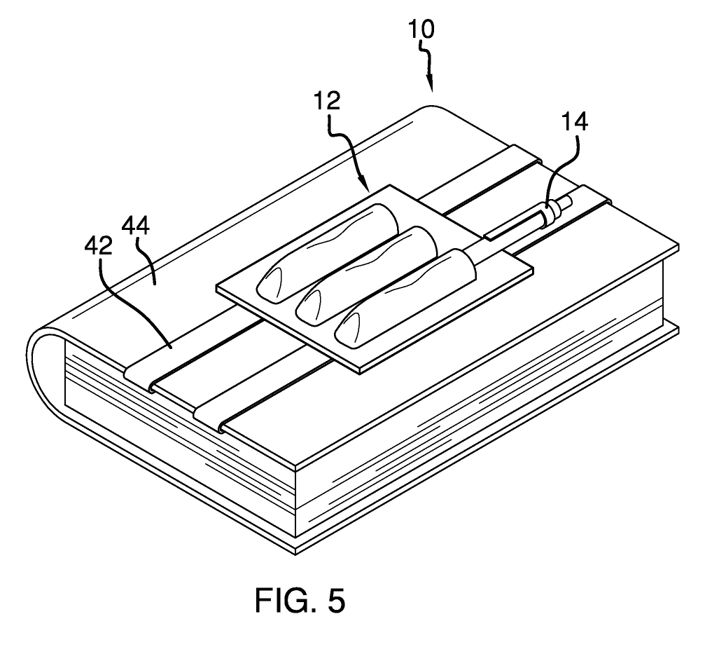

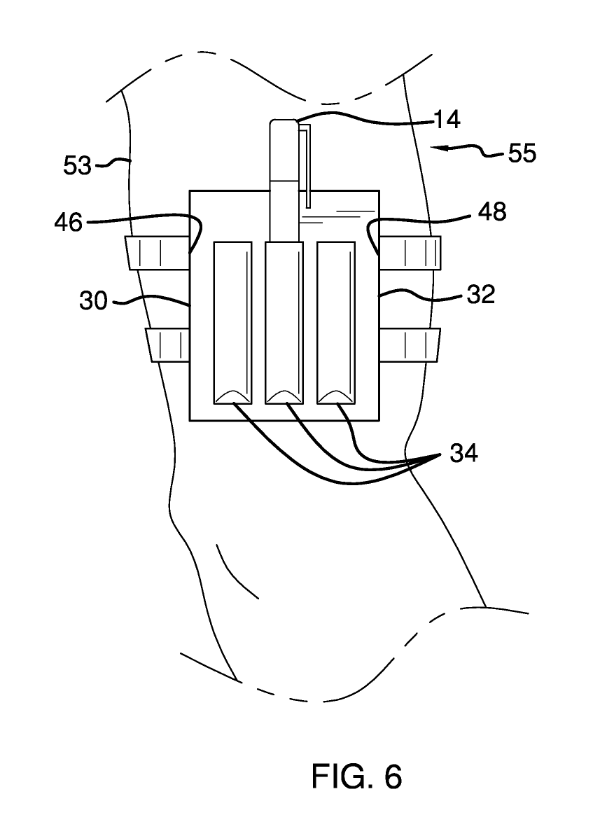

The strap 42 has a first end 46 and a second end 48. The first end 46 is coupled to the top side 26 and the second end 48 is coupled to the bottom side 28. The strap 42 has a break therein to define a first portion 50 and a second portion 52. Additionally, the break defines a distal end 54 of each of the first portion 50 and the second portion 52 with respect to the holder 12. As shown in FIG. 4, the strap 42 may be one of a pair of straps 60 each positioned adjacent to one of the first lateral side 30 and the second lateral side 32 of the perimeter edge 22. In an alternative embodiment as shown in FIG. 6, the first end 46 of the strap 42 is coupled to the first lateral side 30 of the perimeter edge 22 and the second end 48 of the strap 42 is coupled to the second lateral side 32 of the perimeter edge 22. The strap 42 may be wrapped around an arm 53 of a user 55 such that the writing utensils 14 are oriented to extend along the arm 53 of the user 55.

A first coupler 56 and a second coupler 58 are provided. The first coupler 56 is coupled to the first portion 50 and the first coupler 56 is positioned adjacent to the distal end 54 of the first portion 50. The second coupler 58 is coupled to the second portion 52 and the second coupler 58 is positioned adjacent to the distal end 54 of the second portion 52. The first coupler 56 engages the second coupler 58. The first 56 and second 58 couplers may comprise hook and loop fasteners.

In use, the strap 42 is wrapped around the object 44 and the first 56 and second 58 couplers are coupled together. The writing utensils 14 are positioned in the sleeves 24 to be transported on the object 44. The holder 12 may be utilized in an educational environment, a medical environment or an administrative environment. Additionally, the holder 12 ensures the writing utensils 14 are always available.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A writing utensil carrying assembly configured to be coupled to a book or a user's body, said assembly comprising:
a holder configured to contain a plurality of writing utensils;
a strap coupled to said holder, said strap being configured to wrapped around an object such that said holder is retained on the object; and
a first coupler and a second coupler each coupled to said strap, said first coupler engaging said second coupler.

2. The assembly according to claim 1, wherein said holder comprises a panel having a front side, a back side and a perimeter edge extending therebetween.

3. The assembly according to claim 2, further comprising a plurality of sleeves coupled to said front side, said sleeves extending between a top side and a bottom side of said perimeter edge, said sleeves being spaced between a first lateral side and a second lateral side of said perimeter edge, each of said sleeves having an open end, said open end being configured to insertably receive one of the writing utensils.

4. The assembly according to claim 2, further comprising a pocket coupled to said back side, said pocket having an aperture therein, being configured to insertably receive an item.

5. The assembly according to claim 2, wherein:
said perimeter edge has a top side and a bottom side; and
said strap has a first end and a second end, said first end being coupled to said top side, said second end being coupled to said bottom side, said strap having a break therein to define a first portion and a second portion, said break defining a distal end of each of said first portion and said second portion with respect to said holder.

6. The assembly according to claim 5, wherein said first coupler is coupled to said first portion, said first coupler being positioned adjacent to said distal end of said first portion, said second coupler being coupled to said second portion, said second coupler being positioned adjacent to said distal end of said second portion.

7. A writing utensil carrying assembly configured to be coupled to a book or a user's body, said assembly comprising:
a holder configured to contain a plurality of writing utensils, said holder comprising:
a panel having a front side, a back side and a perimeter edge extending therebetween;
a plurality of sleeves coupled to said front side, said sleeves extending between a top side and a bottom side of said perimeter edge, said sleeves being spaced between a first lateral side and a second lateral side of said perimeter edge, each of said sleeves having an open end, said open end being configured to insertably receive one of the writing utensils; and
a pocket coupled to said back side, said pocket having an aperture therein, being configured to insertably receive an item;
a strap coupled to said holder, said strap being configured to wrapped around an object such that said holder is retained on the object, said strap having a first end and a second end, said first end being coupled to said top side, said second end being coupled to said bottom side, said strap having a break therein to define a first portion and a second portion, said break defining a distal end of each of said first portion and said second portion with respect to said holder; and
a first coupler and a second coupler, said first coupler being coupled to said first portion, said first coupler being positioned adjacent to said distal end of said first portion, said second coupler being coupled to said second portion, said second coupler being positioned adjacent to said distal end of said second portion, said first coupler engaging said second coupler.
